(19) United States
(12) Patent Application Publication
(10) Pub. No.: US 2006/0201017 A1
(43) Pub. Date: Sep. 14, 2006

(54) System, apparatus and method for curing of coatings in heavy gas

(76) Inventors: Gregory Page Ellis, New Braunfels, TX (US); Kevin McKay, Spring, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 11/077,073

(22) Filed: Mar. 10, 2005

(51) Int. Cl. F26B 3/34

(52) U.S. Cl. 34/276; 522/148

(57) ABSTRACT

A system, apparatus, and method is provided for curing ultraviolet (UV) curable coatings on articles using UV lamps while the article is immersed in an atmosphere of inert gas heavier than air. One example of a UV curable coating includes 35 weight % Laromer™ LR 8987, 20 weight % urethane acrylate hexandioldiacrylate, 38.5 weight % Laromer™ LR 8863, 3.5 weight % polyetheracrylate Iragucure™ 184, 0.5 weight % of a Photoinitiator Lucirin™ TPO, 2 weight % Tinuvin™ 400 and 1.5 weight % UV absorber Tinuvin™ 292. Examples of the inert gas used in the process disclosed include carbon dioxide, nitrogen, argon, hydrocarbon and halogen gases. An example of an apparatus provided by the invention includes a suspended track system; a housing, wherein the housing comprises an internal portion of the suspended track system and a curing chamber having highly reflective surfaces of favorable geometry. Further provided is a plurality of UV lamps, wherein the lamps are disposed on a slidably removable curing caddy system, wherein the slidable curing caddy enables lamp replacement and general interior maintenance of the apparatus. Further provided is an evaporator and alternatively, a vaporizer for providing a heavy gas supply. Further provided is a controller and software to coordinate the functions of the apparatus disclosed.

The present invention relates generally to the application of curable coatings to articles, and more particularly to a curing apparatus utilizing ultraviolet radiation for curing coatings applied to articles, wherein the coating is cured in an atmosphere of inert gas that has the property of being heavier than air, wherein the inert gas is delivered to the apparatus in a volume sufficient to displace oxygen in a curing chamber.

### BACKGROUND OF THE INVENTION

Radiation curing uses a variety of sources to polymerize a reactive coating material. Ultraviolet light (UV) is the radiation source most frequently used to cure coatings. UV curing is a photochemical process by which monomers having photoinitiators undergo curing (polymerization or cross-linking) upon exposure to ultraviolet radiation.

Methods and apparatus relating to the use of CO₂ gas when curing certain coatings with UV radiation has been described in German patent DE19957900A1 to Beck et al., U.S. Pat. No. 3,956,540 to Laliberte et al., U.S. Pat. No. 4,436,764 to Nakazima et al., U.S. Pat. No. 4,862,827 to Getson, and U.S. Pat. No. 6,620,251 to Kitano.

The present invention relates generally to the application of UV curable coatings to articles, and more particularly to a curing apparatus utilizing ultraviolet radiation for curing coatings applied to articles, wherein the coating is cured in an atmosphere of inert gas that has the property of being heavier than air, wherein the inert gas is delivered to the apparatus rapidly in large volume via a vaporizing means or heat evaporating means.

Radiation curing has become an established and important commercial process and has benefited from the trend away from environmentally unfriendly products such as solvent based thermally cured coatings. Since many radiation curable coatings can cure in seconds, they quickly find their way to applications where continuous processing and the need for higher production speeds are essential in making a financially viable product.

Radiation curing uses a variety of sources to polymerize a reactive coating material. Ultraviolet light (UV) is the radiation source most frequently used to cure coatings accounting for a majority of the volume and market. UV curing is a photochemical process by which monomers having photoinitiators undergo curing (polymerization or cross-linking) upon exposure to ultraviolet radiation. A specially formulated monomer with photoinitiators will polymerize when exposed to ultraviolet radiation. This UV “curable” monomer includes a photoinitiator which absorbs UV energy and initiates a polymerizing reaction therein. The rate or speed of curing will depend on at least the chemical compound, the thickness of the coating, and the amount of UV intensity per unit surface.

The chemical compound itself affects the speed of curing. Each monomer cures at a different rate, depending on its composition and the type and amount of sensitizer, pigment or filling material used. In formulating the UV curable compound, the manufacturer must consider the physical properties of the finished product as well as curing speed.

A general summary of application, markets and products where radiation cured coatings have found commercial success include, but are not limited to, graphic arts coatings, inks, wood, plastics, metal coatings, optical fibers, electrical/electronics and automotive. Some of the more important coating applications are found in every day products such as hardwood flooring, metal and wood furniture, electrical wire and cable, release papers, beverage cans, magazine covers, packaging, leather finishes and computer magnetic media. Although the final properties of radiation cured coatings are often superior to other systems, the reason for their popular growth has been primarily due to improvements in productivity, ability to coat heat and solvent or water sensitive substrates, and environmental emission considerations.

Some of the advantages of processes for curing coatings with radiation include low solvent emissions; low fire hazard; low usage of hazardous solvents, reduced down time, waste, and cleanup; low temperature, solvent free cure process suitable for temperature or chemical sensitive substrates; very fast production, rapid curing, in-line processing capability and minimal manufacturing steps; a variety of different acceptable chemistries and formulations for the coating and inert atmosphere.

Favorable coating and excellent performance properties result, such as high gloss depth, abrasion resistance, chemical resistance, and hardness; smooth finish (unlike powder and some spray coatings).

Machines have been developed for use in the curing process. However, machines do not effectively provide proper lighting geometries. In a proper lighting geometry, the photoinitiator must be exposed to the UV light to effectively cure the coating. In addition to solving the lighting geometries, current machines are able to cure thicker coatings on the product.

Radiation technologies can be used to cross-link or cure organic resins into durable coatings. These durable coatings have excellent physical properties with high chemical and temperature resistance. Radiation curing technology involves at least four considerations; type of radiation source, organic polymer to be irradiated, mechanisms of physical and chemical interaction, and final properties associated with the cured product. Radiation curing coatings react through unsaturation sites on oligomers and monomers. These active sites (double bonds) are capable of reacting to form larger polymers and cross-linked, three dimensional network structures. Reference to FIG. 11 shows the interaction of UV radiation with a linear polymer (a) to develop a cross-linked networked structure (b).

The organic resins useful in the invention include those with a radiation hardendable connections used as bonding agents. These are connections with radical or cation polymerizable chemical groups. In the preferred embodiment, examples of the organic resins include vinylether, vinylamide with maleic acid or fumaric acid and styrene as reactive solvents. In the preferred embodiment, examples are polyester(meth)-acrylates, polyether(meth)acrylate, urethane(meth)acrylate, epoxi(meth)acrylate, silicon(meth)acrylate. Concentrations preferred are 40 mol percent to 60 mol percent radiation hardenable per (meth)acrylate group. Other reactive groups include melamin, isocyanate, epoxy, anhydride, alcohol, groups of carbonic acids for additional thermal hardening. Chemical reaction hardening can also be used in part by substitution of alcohol, carbonic acid, amine, epoxy, anhydride, isocyanates and other methyl groups contained in a binary cure process.

It is widely known that atmospheric oxygen reduces both the rate and extent of UV induced polymeric cross-linking. This oxygen inhibition creates the need for high concentrations of photoinitiator—the most expensive component of UV curable inks, coatings and adhesives. Carbon dioxide (CO₂) inert gas technology eliminates the inhibiting effects of oxygen. The effect of radiation dose on adhesion and cohesive properties of the coating is that as the dose increases, the tack decreases and the cohesive strength of the coating increases. Temperature and chemical resistance are also generally increased by a greater radiation dose. The exact curing window for a product must be determined for every formulation and for each thickness. Ultraviolet light is one of the main sources of energy for curing coatings by radiation. UV light can provide instantaneous curing of coatings that polymerize from a liquid to a solid when irradiated.

During UV curing in air, the presence of oxygen, known as oxygen inhibition, can have a detrimental effect on the cure response for certain coatings. Oxygen reacts with the free radical and forms peroxy radicals by reaction with the photoinitiator, monomer or propagating chain radical. The reactivity of the peroxy radical is insufficient to continue the free radical polymerization process, leading to chain termination and resulting in an under cure system.

One method of overcoming oxygen inhibition is curing the free radical system under an inert gas atmosphere. The inert gas should be heavier than air. The molar weight of the gas should be larger than 28.8 grams per mol and preferably larger than 32 grams per mol (oxygen and 80% nitrogen correspond in the molecular weight of a gas mixture of 20%, for instance). An inert gas atmosphere comprised of noble gases such as argon, hydrocarbon and halogen gases is also acceptable. Carbon dioxide is particularly suitable for use in providing an inert gas atmosphere to overcome oxygen inhibition. It is known that liquid CO₂ can be very conveniently stored and transported in metal cylinders at normal room temperature. It can be easily stored in liquid form due to its inherent nature to be more compact than the gaseous form.

The use of CO₂ gas when curing certain coatings using UV radiation has been described in PCT application PCT/EP00/11589 to Beck, et al., titled “Light Curing of Radiation Curable Materials Under a Protective Gas”. As described in that application, articles are coated with and are placed in an enclosure filled with CO₂ gas. The coating is cured by UV radiation while the article is surrounded by CO₂. The process described by Beck, et al., however, is not easily adapted to a high volume, production environment. Beck, et al. also does not provide for efficient use and conversion of liquid CO₂.

It is desirable that oxygen be eliminated from the curing area to the extent possible. A curing environment that is completely filled with CO₂ provides the best results for the curing process to occur. Articles having coatings that are to be cured are lowered into an airtight enclosure, wherein the enclosure is filled with a heavier than air gas. The article is cured and is then lifted from the enclosure.

The reflector and/or reflective surfaces are important components in a UV curing apparatus system since they directly affect the amount of UV energy that encounters the curing surface. During production, various deposits can accumulate on reflectors and reflective surfaces that will greatly lessen cure efficiency. While some systems do not permit reflectors and/or reflective materials to be changed or cleaned, scheduled interior cleaning helps maintain consistent performance in the curing process. Reflectors, lamps, reflective surfaces, and other interior surfaces that become permanently contaminated, pitted, scratched or that have lost their 10 reflective quality, should be replaced. Currently, most systems, such as Beck, et al., do not provide for easy replacement of these or other internal components.

What is needed, therefore, is a curing system apparatus, and method used for hardening UV curable coatings in an inert gas, such as CO₂, while also having the capability of maintaining high production volumes.

It is further desirable for a curing system and apparatus to permit the operator to easily access the light emitting elements/systems and reflective surfaces for quick and easy change out, cleaning, and/or general interior chamber maintenance. This quick-change, easy internal chamber access feature significantly reduces downtime while also allowing the operator to maintain optimum interior surface reflectivity and system performance all at minimal cost with little production downtime.

It is further desirable for a curing system, apparatus, and method to be adapted provide for efficient storage and conversion of liquid CO₂ to gaseous CO₂ via a vaporizing means or heat evaporation means for use in the curing process and to provide rapid delivery of a large volume of the converted gas to the apparatus via a gas distribution means.

### BRIEF DESCRIPTION OF THE DRAWINGS

The features characteristic of the present invention are set forth in the appended claims. The invention itself however, as well as a preferred mode of use, further objects, and advantages thereof, are best understood by reference to the following detailed description when read in conjunction with the accompanying drawings, wherein:

FIG. 1 is an isometric view of the top and front of the curing apparatus.

FIG. 2 is a detail view of the frame and track of the apparatus.

FIG. 3 is a top view of the apparatus showing certain portions of the support frame and track in ghost as dashed lines.

FIG. 4 is side view of the curing apparatus showing the positioning of the track, products and lamp caddies relative to the housing of the curing apparatus.

FIG. 5 is an isometric view showing the top and back of the curing apparatus.

FIG. 6a and 6b are detail views showing the placement of two light caddies with respect to a portion of the track and suspended product.

FIG. 7 is a schematic diagram of the electrical architecture of the control unit of the curing apparatus.

FIG. 8 is a flow chart of the steps carried out by the controller of the curing apparatus.

FIG. 9 is a plan view of the manifolds of the apparatus.

FIG. 10 shows a schematic representation of the interaction of UV radiation with a cross-linking linear polymer.

### DETAILED DESCRIPTION

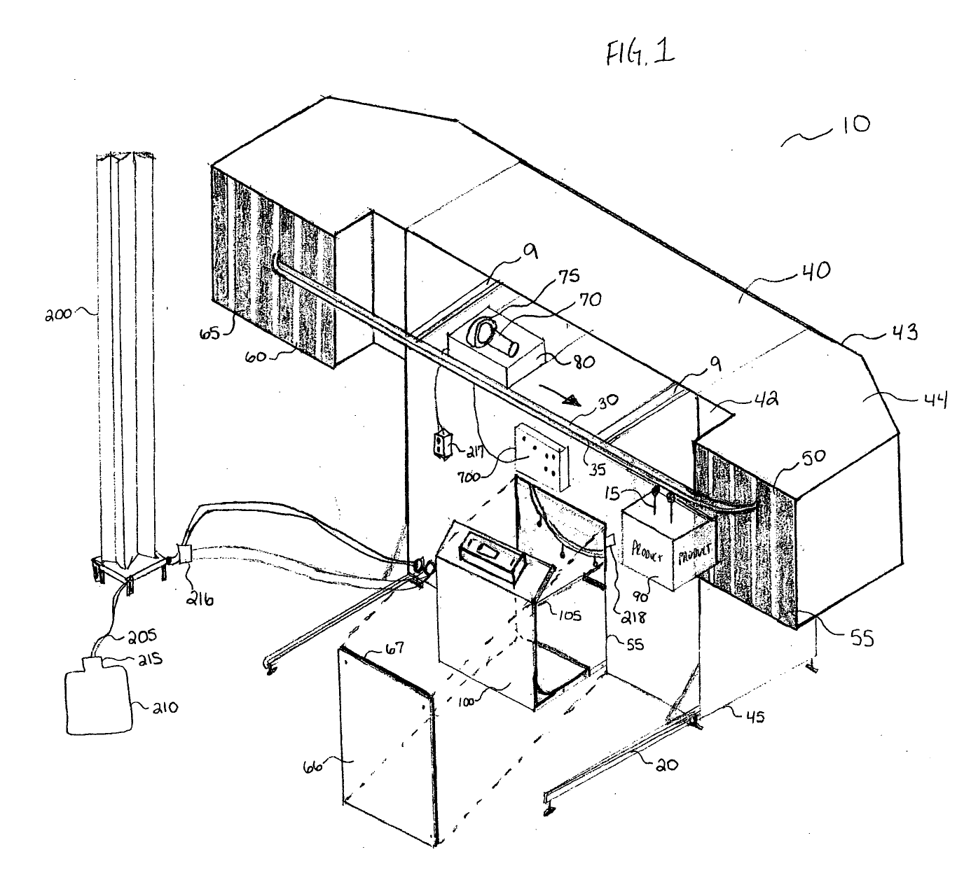

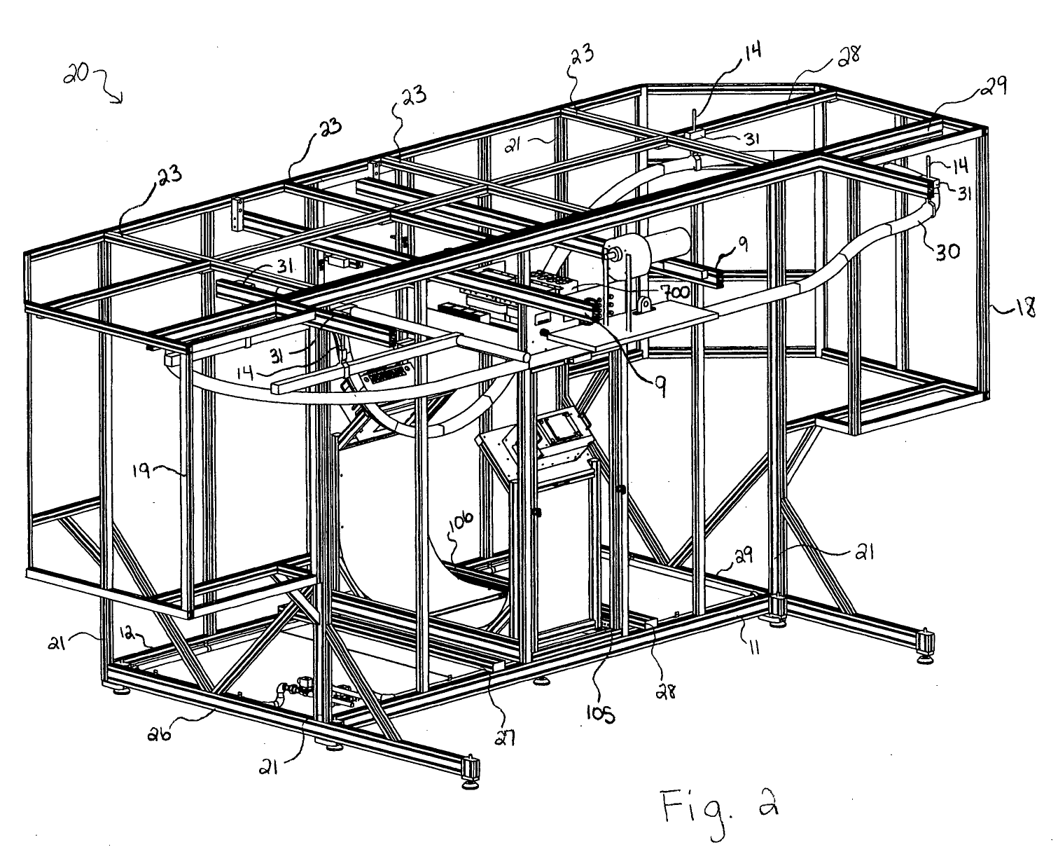

FIG. 1 shows and isometric view of curing apparatus 10. Curing apparatus 10 includes support frame 20. Support frame 20 provides the internal structure which supports the operating components of the apparatus and the products which are cured by it. Support frame 20 is shown in detail in FIG. 2. Support frame 20 includes a plurality of upward supports 21, a plurality of upper longitudinal supports 23 and 15, lower longitudinal support members 26, 27, 28, and 29, lower latitudinal support members 11 and 12 and upper lateral support members 28 and 29. Support frame 20 also includes entry supports 18 and exit supports 19. In the preferred embodiment, the support frame is constructed of 2-inch box aluminum channel. Other rigid materials can be used for the frame such as steel.

A generally oval track 30 is suspended from upper lateral support members 28 and 29. Track 20 is supported in four places, one support (shown as 13); by upper lateral support member 28 and three (shown as 14) by lateral support member 29. The track is attached to the support frame by spacers 31 which provide for leveling of the track.

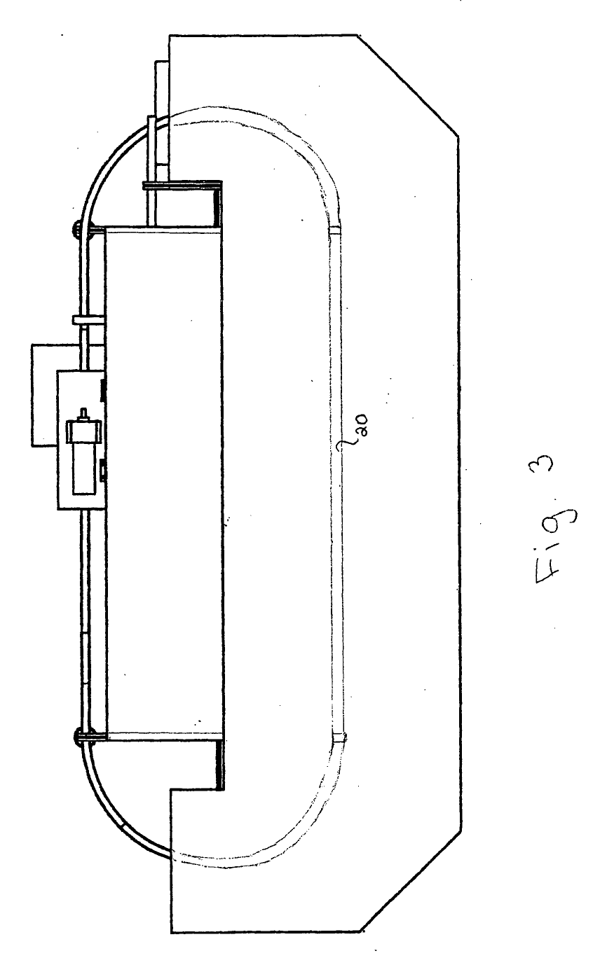

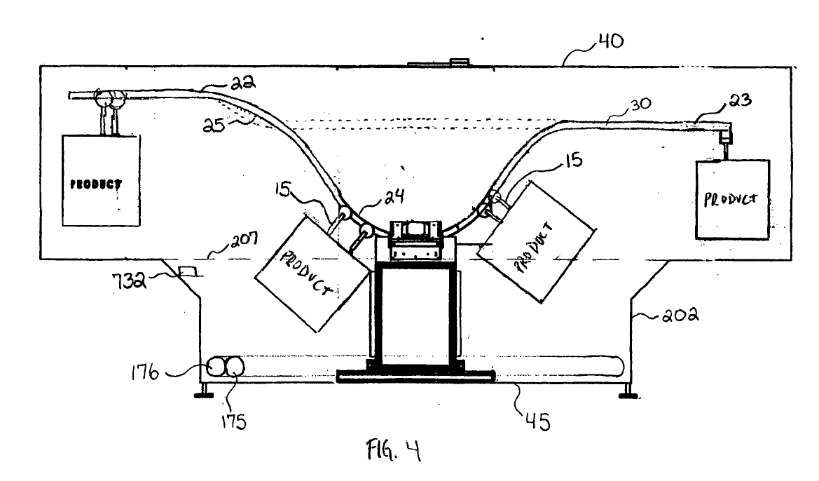

Turning to FIG. 4, track 30 is shown from a side view. Track 30 comprises an upper section 22, a lower section 23 and a descending/ascending section 24. Upper section 22 is connected to descending/ascending section 24 through a curved radius of approximately 4 feet. Descending/ascending section 24 forms a radius also of approximately 4 feet. Descending/ascending section 24 is connected to lower section 23 by a radius of curvature of approximately 3 feet. Lower section 23 is connected to upper section 22 through elevated ascent 25, having a radius of curvature of approximately 2 feet. The distance between upper section 22 and lower section 23, vertically, is approximately 8 inches. The distance between upper section 22 and the lowest point of descending/ascending section 24 is approximately 4 feet. In the preferred embodiment, the aspect ratio of track 30 as seen from the top (FIG. 3) is approximately 4 to 1. Of course, each of the dimensions of the track is subject to engineering choice and can be modified within the scope and spirit of the invention.

Track 30 is made up of aluminum tubing with a round cross-section, having a linear slot of approximately ½ inch centered at the bottom side of the tubing. A continuous chain (not shown) resides within track 30. The continuous chain is comprised of cylindrical rollers. The cylindrical rollers are sized to fit within the track at alternating angles of 45° and 135° from the vertical axis of the diameter of the track. The cylindrical rollers are spaced at intervals of approximately 6 inches and are connected by a continuous chain. Properly lubricated, the continuous chain and rollers can be moved to traverse the inside of the track in a continuous loop.

Hangers 15 are attached at regular intervals on the chain through the slot in the bottom side of track 30. In the preferred embodiment, the hangers are designed to support a load between 5 and 20 pounds. The bottom of each hanger 15 is designed to support a product 90 and to articulate or swing to allow movement by the suspended product. If the weight of product 90 exceeds the capacity of a single hanger 15, additional hangers can be added to the continuous chain to support the additional weight.

FIG. 1 shows drive motor 70, reduction gear box 75 and cog drive 80. Cog drive 80 is connected to the continuous chain through an opening (not shown) in the top of track 30. The cog drive is driven by reduction gearbox 75, which is in turn driven by drive motor 70. The cooperation of drive motor 70, reduction gearbox 75 and cog drive 80 in the preferred embodiment provides a travel speed in the chain of approximately 5 to 10 feet per minute. In another embodiment, travel speeds in the chain can range from about 1 to about 30 feet per minute. In the preferred embodiment, drive motor 70 is an adjustable speed, fractional horsepower 110-volt AC motor. Reduction gearbox 75, drive motor 70 and cog drive 80 are mechanically supported by upper lateral supports 15. In the preferred embodiment, the track, motor and drive components are provided by Pacline Corporation of Canada.

Support frame 20 and track 30 are partially enclosed by housing 40. Housing 40 includes a front side 42, a back side 43, a top 44 and a bottom 45. The front and back sides, top and bottom are made of aluminum panels fitted to the frame and sealed in place to form a generally airtight box. Housing 40 forms a gas basin 202. In the preferred embodiment, the gas basin is approximately 3 feet deep and comprises a volume of approximately 60 cubic feet. Of course, in other embodiments, the depth of the gas basin and its volume can be raised or lowered to accept smaller or larger products, respectively.

Housing 40 has 4 openings, an entrance 50, an exit 60, a front curing chamber access portal 55 and a back curing chamber access portal 65 (shown best in FIG. 4). Entrance 50 and exit 60 are positioned to block light emitted from the curing basin. Entrance 50 is loosely covered by curtain 55. Exit 60 is loosely covered by curtain 65. Curtains 55 and 65 are comprised of strips of transparent polypropylene in the preferred embodiment. In other embodiments, other curtain materials may be effectively utilized which give way to regular sized objects easily. Front curing chamber access portal 55 is sealed by a front access panel 66. Front access panel 66 is designed to slightly overlap front curing chamber access portal 55. Front access panel 66 has a around its perimeter a rubber seal 67. In its closed position, rubber seal 67 forms a fluid tight seal between front access panel 66 and front side 42.

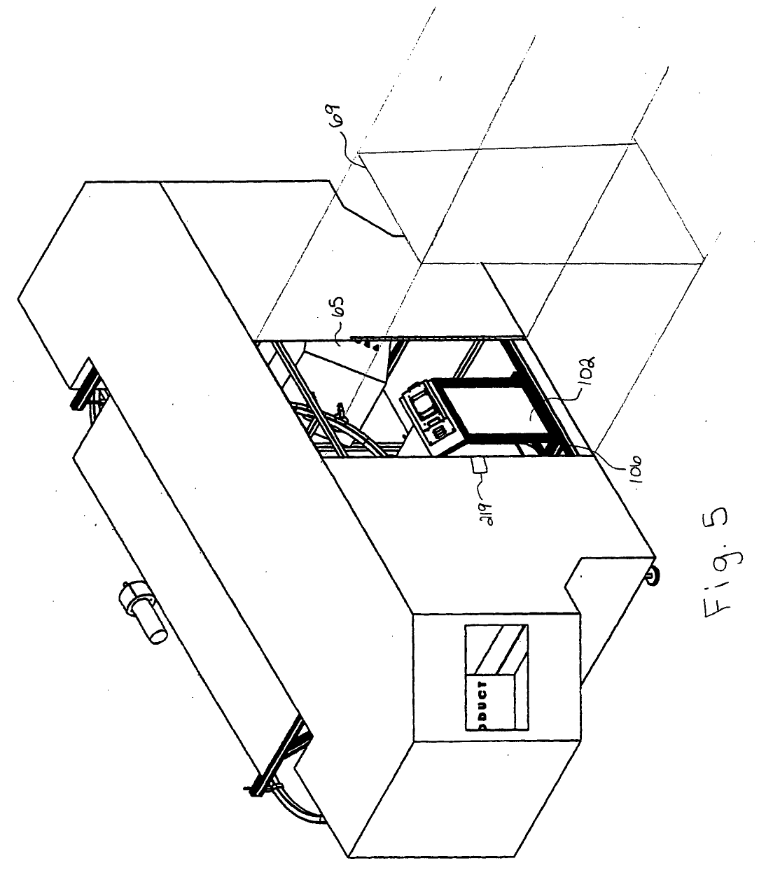

As seen in FIG. 5, rear access panel 68 is designed to overlap the back of curing chamber access portal 65. Rear access panel 68 is provided with a peripheral rubber seal 69 around its inside edge. When in its closed position, rear access panel 68 forces rubber seal 69 against back side 43, providing a fluid tight seal. Front access panel 66 is mechanically attached to front side 42 through machine screws. Similarly, rear access panel 68 is attached to curing chamber access portal 65 through machine screws. Of course, other removable attachment devices can be used.

The front access panel and the rear access panel, respectively, provide access to front light caddy 100 as seen in FIG. 1 and rear light caddy 102 as seen in FIG. 5. Front light caddy 100 is mounted on sliding track 105. Sliding track 105 allows front light caddy 100 to be extended outward through front curing chamber access portal 45 and removed. Rear light caddy 102 is supported by siding track 106. Siding track 106 allows rear light caddy 102 to be moved linearly out of back curing chamber access portal 65. In use, each sliding track is used to remove the light caddies for cleaning and maintenance. In other embodiments, the sliding track may be replaced by a remotely actuated linear actuator such as a hydraulic or pneumatically driven piston and cylinder. In other embodiments, the linear slide may be replaced by a set of roller bearings or linear wheels on opposed sides of the light caddy to enable easy movement with respect to the curing basin. In yet another embodiment, the light caddies may be hinged to pivot out of the access portal facilitating access to the reflectors and rack lights.

In the preferred embodiment, only two light caddies are employed. In alternate embodiments, additional light caddies can be employed to add additional light intensity. The light caddies provide an optimum geometry for generation and delivery of light to the product through a combination of angled light support panels and cooperating parabolic reflectors.

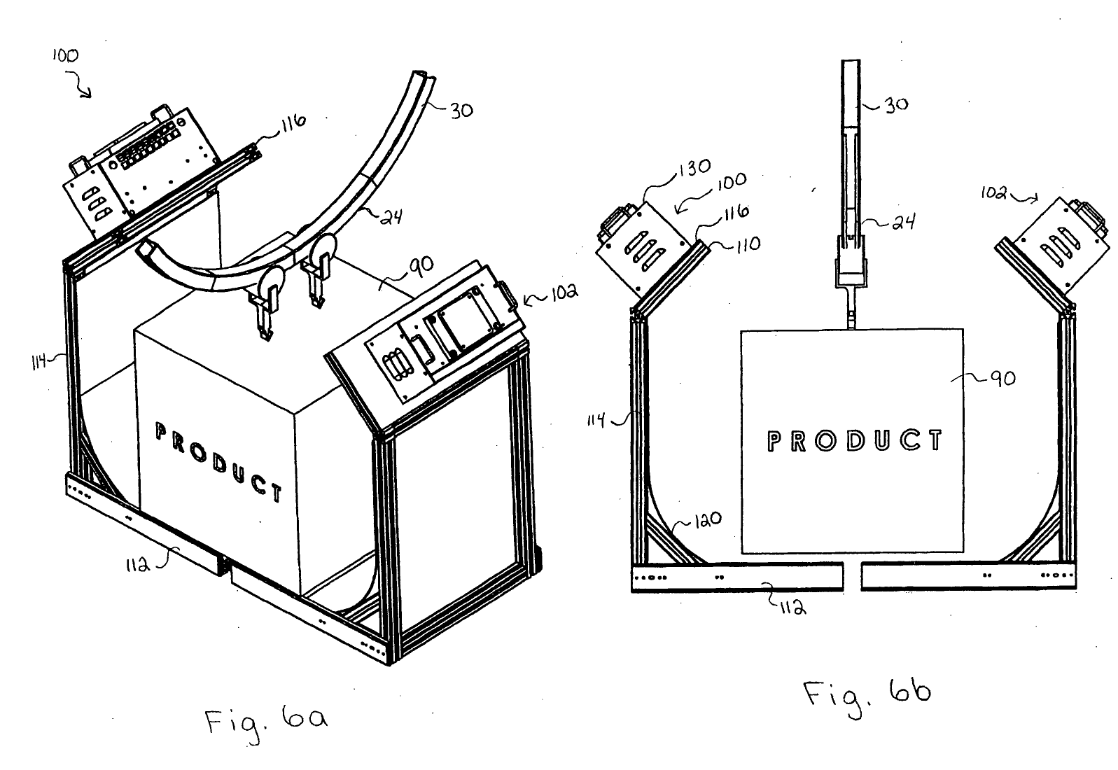

The structure of each light caddy can best be seen from FIGS. 6a and 6b. The light caddies are mirror images of each other and therefore, only one will be described for brevity. Front light caddy 100 includes a reflector support frame 110. Reflector support frame 110 is made up of aluminum channel in a box-like structure including bottom support rails 112, upright support rails 114 and light support panel 116. Light support panel 116 supports rack light 130. Rack light 130 is positioned in light support panel 116 to shine through and be directed toward product 90. The light support panel in the preferred embodiment forms an additional 45° angle with the upright support racks and serves to direct the light of the rack light toward the center of the product. The interior of reflector support frame 110 is covered with a flexible reflector 120. In the preferred embodiment, flexible reflector 120 is polished to a reflectivity of between 80 and 90% and forms a parabolic curve along the interior of support frame 110. The parabolic reflector has a focal point to direct light from each of the rack lights toward the center of the product. When assembled, the parabolic reflections of both light caddies completely irradiate the bottom and sides of the product with light from the opposing rack lights. Flexible reflector 120 in the preferred embodiment is made of stainless steel available from Superior Company of in a size of 44 inches by 23 inches, part no. 020-00183. In alternative embodiments, flexible reflector 120 is made of polished aluminum or reflectorized flexible plastic.

Rack light 130 in the preferred embodiment houses mercury filled ultraviolet lamps having an arc length of approximately 6 inches drawing approximately 200 watts of current. The lamps have a warm-up time of approximately 3 to 5 minutes in order for the arc to create sufficient plasma to generate ultraviolet light. In the preferred embodiment, rack light 130 is model number MC6-200, manufactured by Ultraviolet Systems, Ltd. of Houston, Tex., USA. In alternate embodiments, ultraviolet lamps having low, medium or high pressure gas can be used as well as doped lamps including amalgam, gallium or iron. Each of the rack lights has an integral cooling fan of sufficient power to maintain the rack light at an acceptable continuous operating temperature. In other embodiments, other power ranges and gas mixtures can be utilized to cure different coatings.

As shown in FIGS. 6a and 6b, when used in combination, front light caddy 100 and rear light caddy 102 illuminate product 90 from all sides with high intensity ultraviolet light.

The relationship in position between track 30 and light caddies 100 and 102 is also shown in FIGS. 6a and 6b. Descending/ascending section 24 of track 30 is centrally placed between light caddies 100 and 102. Additionally, the lowest juncture of descending/ascending section 24 occurs such that hangers 15 and product 90 extend below and into the light generated by light caddies 100 and 102.

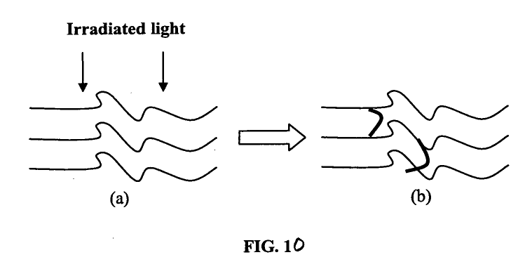

Returning to FIG. 4, gas manifolds 175 and 176 can be seen at the base of gas basin 202 in housing 40. In the preferred embodiment, gas manifolds 175 and 176 are placed in the bottom of housing 40 and are held in place through attachments to lower lateral support members 26 and 27 of frame 20. A top view of gas manifolds 175 and 176 is shown in FIG. 10. Gas manifold 175 is comprised of ¾ inch aluminum tubing having a threaded opening 177 and a sealed end 178. Likewise, gas manifold 176 is a threaded opening 179 and a sealed end 180. Both gas manifolds 175 and 176 are perforated on their interior with multiple gas orifices. In the preferred embodiment gas orifices are drilled with a No. 20 drill at about a 120 degree angle from the top of each manifold. Drilling the gas orifices at this angle provides for a gas flow out of the manifolds at a downward angle toward bottom 45 of housing 40.

Returning to FIG. 1, threaded opening 177 and 179 of gas manifolds 175 and 176 respectively, are connected to an evaporator 200 through hoses 195 and 196. In the preferred embodiment, evaporator 200 is available from Carbo Tech, Inc. of Monroe, Ga., USA. In the preferred embodiment, the evaporator can produce a flow rate of up to 720 lbs/hr at 70° F. Evaporator 200 is connected to CO₂ cylinder 210 through hose 205. In the preferred embodiment, a pressure regulator 215 and an electrically variable gas valve 216 control the flow of CO₂ from CO₂ cylinder 210 to evaporator 200 and in turn, to gas manifolds 175 and 176. In the preferred embodiment, the pressure regulator is part no. SR-310 500 PSIG available from Victor Company of Denton, Tex., USA

In an alternate embodiment, CO₂ cylinder 210 and evaporator 200 can be replaced by a CO₂ vaporizer. In this alternative embodiment, an adequate CO₂ vaporizer is sold under the brand name MV6, of 150 lbs/hr capacity, sold by Cryogenic Experts, Inc., of Oxnard, Calif., USA.

Gas level sensor 732 is located within housing 40 at a height approximately equal to the lowest level of descending/ascending section 24 of track 30. In the preferred embodiment, gas level sensor 732 is comprised of an oxygen sensor connected to an oxygen analyzer. Gas level sensors are known in the art. In the preferred embodiment, the gas level sensor is set to detect when less than 5% O₂ by volume is present in the curing basin.

The functions of the apparatus are controlled by a controller 700 mounted by upper lateral supports 15. The controller is connected to the pressure regulator 215, the variable gas valve dial 216, drive motor 270, each rack light, a start switch 738, a stop switch 736, front access panel indicator switch 218 and rear access panel indicator switch 219 through appropriate wiring (not shown).

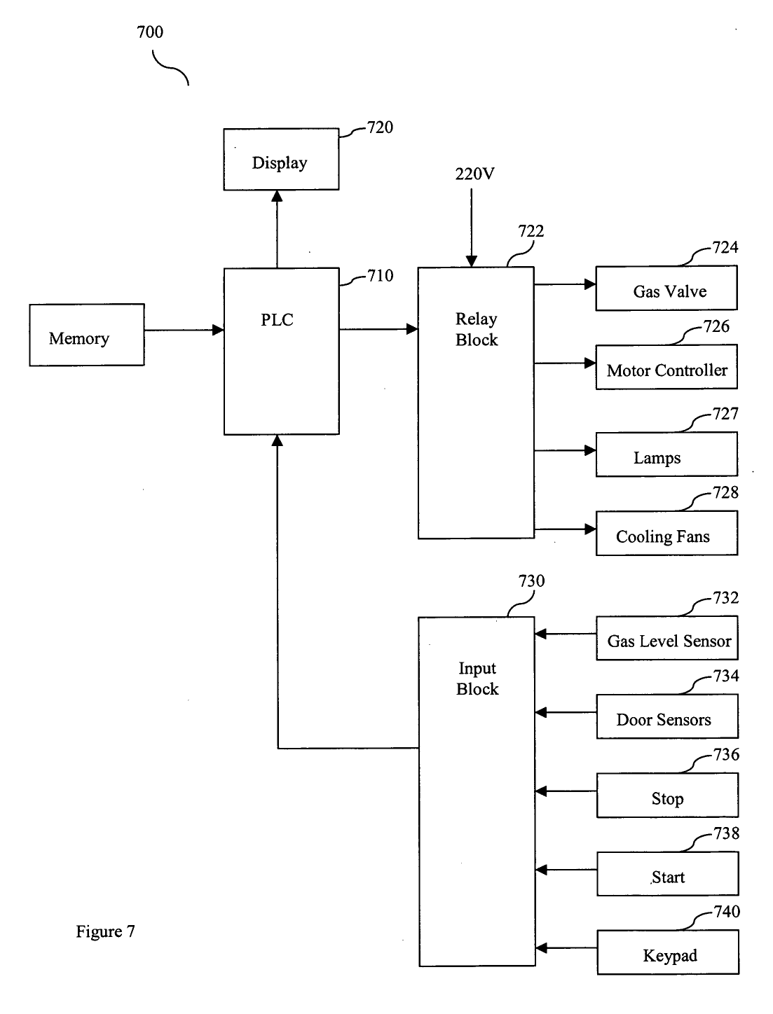

FIG. 7 shows the logical arrangement of controller 700. Controller 700 is operated by a programmable logic controller 710. In the preferred embodiment, programmable logic controller 710 is a “PICO” type programmable logic controller available from Allen-Bradley of Milwaukee, Wis., USA. Of course, other controllers such as a personal computer can be used in other embodiments. In the preferred embodiment, ladder logic programming is used to instruct the programmable logic controller how to carry out its functions. Programmable logic controller 710 is connected to relay block 722. Relay block 722 includes circuitry to convert digital signals from programmable logic controller 710 into analog signals with sufficient current to drive the various peripheral devices required by the apparatus. Relay block 722 is connected to variable gas valve 216 through a connection 724. Relay block 722 is connected to drive motor 70 through a connection at 726. Connection 726 includes a motor controller capable of altering the speed of drive motor 70 and applying sufficient current for that purpose.

Relay block 722 is also connected to each of the rack lights through a connector at 727. Relay block 722 is also connected to the cooling fans directly adjacent to the lamps that operate to lower lamp temperature during operation and reduce temperature after operation of the lamps to room temperature.

Programmable logic controller 710 is also connected to input connector block 730. Input connector block 730 is capable to accepting analog signals from the various peripheral devices required by the apparatus and converting them into digital signals accepted by programmable logic controller 710.

Input connector block 730 is connected to gas level sensor 732.

Gas level sensor 732 provides a variable voltage output representing the amount of oxygen present. The oxygen analyzer is connected through an RS232 port to input connector block 730 which in turn is connected to programmable logic controller 710.

Input connector block 730 is connected to front access panel indicator switch 218 and rear access panel indicator switch 219 through a connector 734. The access panel indicator switches each produce a binary output which can be interpreted as “door open” or “door closed”. In the preferred embodiment, each of these switches is a pressure switch located between the access panel and housing 40.

Input connector block 730 is also connected to an analog stop switch 736, an analog start switch 738, and a numerical keypad 742 for entry of digital data, as required by the programmable logic controller to perform its functions.

Programmable logic controller 740 is also connected to durable memory 728. In the preferred embodiment, durable memory 728 is a battery backed up RAM. Of course, in other embodiments, durable memory 728 can be peripheral memory, magnetic or optical disk drives or network memory connected to the programmable logic controller through a network connection.

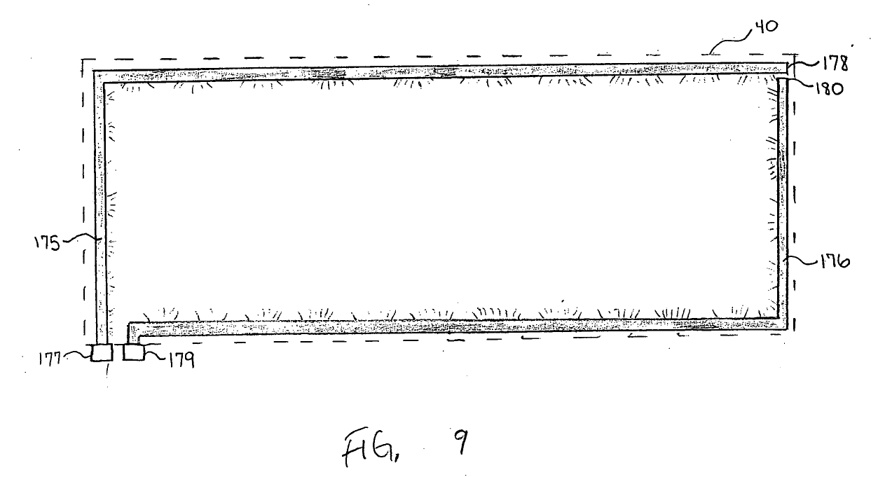

In operation, programmable logic controller 710 initiates a program, the steps of which are shown in FIG. 9, to operate the functions of the curing apparatus.

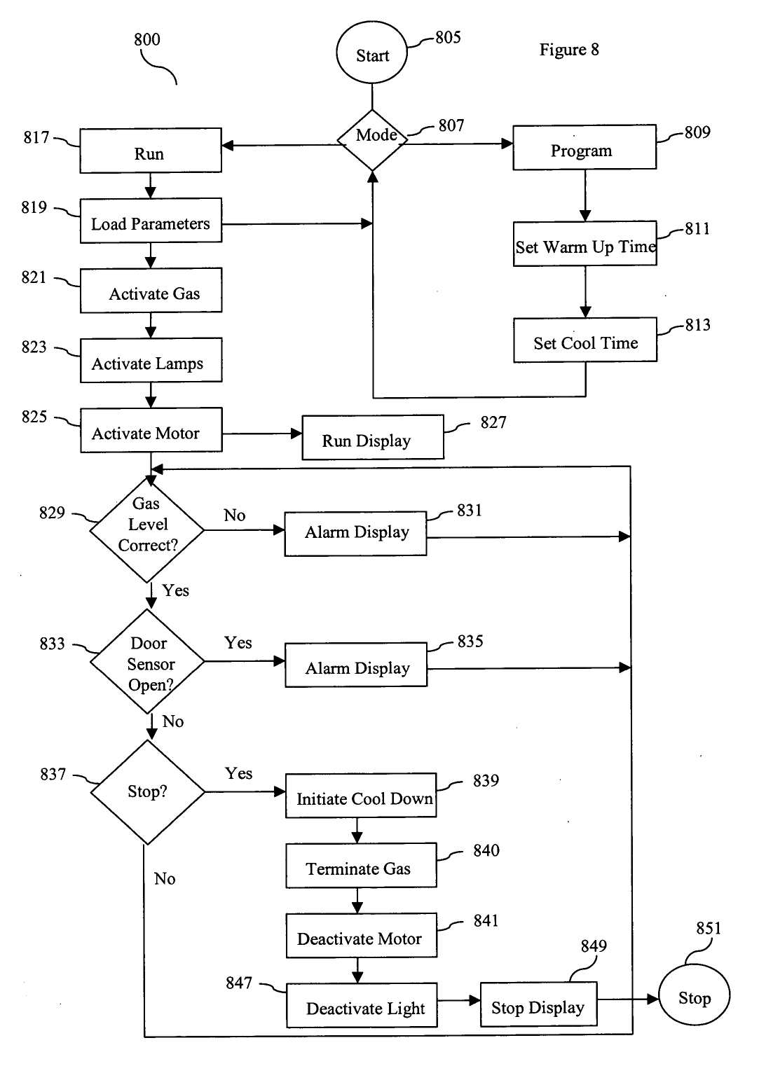

Referring then to FIG. 8, the program is initiated at start block 805. As a first step, the program requires input to determine if it should enter run mode 817 or program mode 809. Upon entry into program mode 809, several parameters are required to be set for the operation of the curing apparatus. Initially, a timer is set to delay startup until the lamps have reached operation temperature. Program mode 809 then requires an input of the cool-down time for the rack lights at step 813 other parameters such as the speed of the continuous chain, rate of heavy gas flow, curing time and automatic start and stop times can be programmed in other embodiments. Upon proper entry of the required data parameters, the program returns to mode selection 807.

Upon entry into run mode at 817, the program loads the parameters previously input in program mode. If the parameters are not present, the program returns to mode selection 807. If program parameters are present, the program activates the apparatus by first activating gas valve 216 to initiate gas flow at step 821. When gas flow is activated, CO₂ gas from CO₂ cylinder 210 is admitted to evaporator 200 through gas valve 216, pressure regulator 215, and hose 205. CO₂ cylinder 210 provides liquid CO₂ to the evaporator. Evaporator 200 converts the liquid CO₂ into gaseous CO₂. The gaseous CO₂ travels into pressure regulator 215 to gas manifolds 175 and 176 through threaded openings 177 and 179 and into the gas basin through the orifices.

Once the gas enters gas manifolds 175 and 176, the gas is distributed through the manifolds and enters housing 40 at its lowermost point. Referring to FIG. 4, it can be seen that housing 40 provides a gas basin 202. The CO₂ gas, being heavier than air, fills gas basin 202 to a predetermined level. Consequently, the CO₂ gas displaces the oxygen and other gases present in gas basin 202 before operation of the apparatus. Gas basin 202 therefore provides an oxygen free environment within housing 40.

In other alternate embodiments, other noble gases such as nitrogen, argon, hydrocarbons, 10 or halogenated hydrocarbons can be used to provide an oxygen free environment within gas basin 202. FIG. 4 also shows, by a dashed line, gas level 207.

At step 823, the program activates rack lights 130. Depending on the type of lamp used, a warm-up period may be required. A delay is instituted as programmed in the parameters to allow the rack lights to rise to operating temperature. Upon activation of the rack lights at step 823, the program also activates the cooling fans. Once at operating temperature, rack lights 130 produce an intense ultraviolet light which is reflected from each of the flexible reflectors 120 resulting in a high ultraviolet light intensity between the light caddies and below the surface of the heavy gas.

At step 825, the program activates drive motor 70. Its speed is adjusted by its controller 726 to correspond with the desired speed of the continuous chain. Drive motor 70 in turn activates reduction gearbox 75 and cog drive 80 to motivate the continuous chain. Simultaneously, the program sends a message through programmable logic controller 710 to display 720 to indicate a “run” condition indicating that the curing apparatus is functioning.

In use, one or more products 90 are attached to hangers 15. The products are moved by the continuous chain in a counterclockwise fashion along upper section 22 of track 30. Product 90 is supported and moved by continuous chain 35 around track 30, through curtain 55 and into entrance 50 in curing apparatus 10. Hangers 15 and product 90 follow track 30 into descending/ascending section 24 of track 30. Upon entering the descending/ascending section of the track, the products enter gas basin 202 and fall below gas level 207, as can be seen in FIG. 4. Product 90 passes between front light caddy 100 and rear light caddy 102 and underneath rack lights 130.

While in gas basin 202 and between the front and rear light curing caddies, the ultraviolet sensitive coating on the product cures. In the preferred embodiment, the product is immersed in gas basin 202 and resident between the curing caddies for approximately 1 to 2 minutes. Of course, this time can be adjusted by adjusting the speed of drive motor 70 or adding a delay to the motor of the chain.

Hangers 15 and product 90 then ascend the track to lower section 23. During the product's movement from upper section 22 to lower section 23, the weight of the product contributes energy to the continuous chain because its potential energy while at upper section 22 is greater than its potential energy at lower section 23. The additional energy provided by gravity acting on the product reduces the amount of drive power necessary from drive motor 70 and further reduces friction and wear on the continuous chain 35 within track 30. Additionally, the lower height of lower section 23 allows for a shorter overall track length by eliminating an added section of track required to return to the height of upper section 22.

Returning to FIG. 8, the program enters a loop after step 825, starting at step 829 by checking gas level sensor 203 to determine if gas basin 202 is indeed completely filled with heavy gas. The variable voltage output of gas level sensor 732 is used by programmable logic controller 710 to proportionately open or close gas valve 724. If the oxygen reported by gas level sensor 732 is high, programmable logic controller 710 opens variable gas valve 216 proportionately to allow more CO₂ to enter gas basin 202. As the level of oxygen drops, gas level sensor 732 proportionately reduces voltage to input connector block 730 and programmable logic controller 710. If not, an alarm display is sent to display 720 by programmable logic controller 710 at step 831. If the gas level is sufficient, then the program checks to assure that front access panel indicator switch 218 and rear access panel indicator switch 219 are closed. If not, an alarm is sent from programmable logic controller 710 to display 720 at step 835. If both access panels are indeed closed, the program proceeds to step 837. At step 837, programmable logic controller 710 polls the input connector block 730 to determine if stop switch 736 has been activated. If not, the loop returns, repeating step 829 and following, allowing continuous function of the curing apparatus.

After leaving gas basin 202, product 90 supported by hanger 15 is moved by guide chain 35 through curtain 65 at exit 60, leaving curing apparatus 10. During the process, the uncured UV coating on product 90 becomes cured and hardened. The product is then removed from hangers 15, completing the process.

If the stop switch 736 has been activated, then a cool-down procedure is initiated at step 839. Upon initiating cool-down, gas flow is terminated at step 840 by deactivating solenoid valve 216. At step 841, drive motor 70 is deactivated through a gradual slowing of its speed to zero to avoid an instantaneous stop of all products supported by the continuous chain. Once the motor has been deactivated, the program deactivates the rack lights at step 843. At step 845, programmable logic controller 710 sends a cool-down display message to be displayed by display 720. The cooling fans are allowed to run for the time indicated by the parameters 819 as set by step 813 in program mode 809. At step 849, the display is sent a “stop” message indicating, indicating a stop condition of the apparatus and the program terminates at step 851. After step 851, a loop is entered, checking for start condition 738 which will then return the program to step 805.

In an alternate embodiment, the steps carried out by programmable logic controller 710 in program 800 can be accomplished manually. In this process, the drive motor and gas are manually activated. Gas level 207 is maintained in gas basin 202 by a hand held device suitable for monitoring CO₂ levels or alternately, the lack of oxygen levels.

### EXAMPLE 1

A preferred example of the radiation hardenable curing an inert gas composition and process parameters are given below.

Irradiation hardenable coating comprising 35 weight % Laromer™ LR 8987 (available from BASF Corporation of Germany), 20 weight % urethane acrylate hexandioldiacrylate, 38.5 weight % Laromer™ LR 8863, (available from BASF Corporation of Germany), 3.5 weight % polyetheracrylate Iragucure™ 184 (Ciba Corporation).

0.5 weight % of a Photoinitiator Lucirin™ TPO (available from BASF Corporation).

2 weight % Tinuvin™ 400 (Ciba Special Chemistry), 1.5 weight % UV absorber Tinuvin™292.

In this example, each rack light had a power rating of approximately 500 watts placed a distance of approximately 6 inches from the product. The travel speed for the conveyor was approximately 15 feet per minute.

In this example, the gas level was approximately 30 inches. In this example, the gas level was CO₂ with less than 5% oxygen present in the curing basin. The resulting finish on the product was clear lacquer and was highly scratch resistant.

This invention is susceptible to considerable variation in its practice. Accordingly, this invention is not limited to the specific exemplifications set forth herein above. Rather, this invention is within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part of the invention under the doctrine of equivalents.

1. A system for curing an article with light in a heavy gas comprising:
a curing basin;
a supply means, connected to the curing basin, for delivering heavy gas to the curing basin;
a light irradiation means, within the curing basin, for delivering light to the curing basin; and
a suspension means, within the curing basin for moving the articles through the curing basin; and
a carriage means, removably positioned in the curing basin, for supporting the light irradiation means.

2. The system of claim 1 wherein the carriage means comprises
a frame;
a reflector attached to the interior of the frame;
a modular light source attached to the frame for illumination of the reflector; and
a transfer means, attached to the frame and to the curing basin, for facilitating movement of the carriage means with respect to the curing basin.

3. The system of claim 2 wherein the transfer means includes a linear slide.

4. The system of claim 2 wherein the transfer means includes an opposed set of wheels.

5. The system of claim 2 wherein the transfer means includes a pivoted hinge.

6. The system of claim 2 wherein the irradiation means includes an interior reflector.

7. The system of claim 6 wherein the internal reflector is polished aluminum.

8. The system of claim 6 wherein the internal reflector is stainless steel.

9. The system of claim 6 wherein the internal reflector is coated fluoro plastic.

10. The system of claim 6 wherein the internal reflector has a reflectivity of between about 85 and about 95%.

11. The system of claim 6 wherein the internal reflector has a parabolic section.

12. The system of claim 6 wherein the internal reflector is positioned to reflect light from the light irradiation means onto the article.

13. The system of claim 6 wherein the internal reflector is positioned to focus on the article.

14. The system of claim 2 wherein the carriage means includes a cooling fan.

15. The system of claim 1 wherein the irradiation means includes an ultraviolet light source.

16. The system of claim 15 wherein the ultraviolet light source further comprises a light source having an arc length of about 6 inches.

17. The system of claim 15 wherein the ultraviolet light source further comprises a light source having a power rating of about 200 watts.

18. The system of claim 15 wherein the ultraviolet light source further comprises a light source having a linear tube lamp.

19. The system of claim 15 wherein the ultraviolet light source further comprises a light source having an amalgam doped lamp.

20. The system of claim 15 wherein the ultraviolet light source further comprises a light source having a gallium doped lamp.

21. The system of claim 15 wherein the ultraviolet light source further comprises a light source having an iron doped lamp.

22. The system of claim 15 wherein the ultraviolet light source further comprises a light source having a memory arc lamp.

23. The system of claim 1 wherein the suspension means comprises a continuous track, a conveyor in the track, a motivator for moving the conveyor and an attachment means, connected to the conveyor for holding the article.

24. The system of claim 23 wherein the motivator comprises a motor and a drive mechanism connecting the motor and the conveyor.

25. The system of claim 24 wherein the motor has a power rating of about ½ horsepower.

26. The system of claim 1 wherein the supply means comprises a liquid CO₂ supply connected to an evaporator.

27. The system of claim 26 further comprising a pressure regulator connected to the evaporator and the curing basin.

28. The system of claim 1 wherein the supply means comprises a heavy gas source and a manifold within the curing basin.

29. The system of claim 28 wherein the manifold has a plurality of downwardly facing orifices.

30. The system of claim 29 wherein the manifold surrounds the periphery of the curing basin.

31. The system of claim 1 wherein the heavy gas is one of CO₂, nitrogen, argon, hydrocarbon or halogen.

32. The system of claim 1 wherein the supply means is a vaporizer.

33. The system of claim 1 wherein the curing basin is about 3 feet deep.

34. The system of claim 1 wherein the curing basin has a volume of approximately 60 cubic feet.

35. The system of claim 1 wherein the curing basin is airtight.

36. The system of claim 1 wherein the heavy gas is a noble gas.

37. The system of claim 1 wherein the article is coated with a composition of light curable resin.

38. The system of claim 1 wherein the article is coated with a composition including Laromer™ LR 8987, urethane acrylate hexandioldiacrylate, Laromer™ LR 8863, polyetheracrylate Iragucure™ 184, Photoinitiator Lucirin™ TPO, Tinuvin™ 400 and UV absorber Tinuvin™ 292.

39. The system of claim 1 wherein the article is coated with a composition including 35 weight % Laromer™ LR 8987, 20 weight % urethane acrylate hexandioldiacrylate, 38.5 weight % Laromer™ LR 8863, 3.5 weight % polyetheracrylate Iragucure™ 184, 0.5 weight % of a Photoinitiator Lucirin™ TPO, 2 weight % Tinuvin™ 400 and 1.5 weight % UV absorber Tinuvin™ 292.

40. The system of claim 1 wherein the heavy gas is heavier than air at standard temperature and pressure.

41. The system of claim 1 further comprising a controller connected to the supply means, the light irradiation means and the suspension means and programmed to complete the following steps:
instruct the supply means to deliver heavy gas to the curing basin;
activate the light irradiation means; and
activate the suspension means.

42. An apparatus for curing a coated article comprising:
a sealed housing having an entrance portal, an exit portal and a curing chamber;
a conveyor track extending into the entrance portal, through the curing chamber and out of the exit portal;
a conveyor chain within the conveyor track;
a hanger on the conveyor chain configured to support the coated article;
a driver motor engaging the conveyor chain and configured to move the conveyor chain within the conveyor track;
a heavy gas supply connected to the housing and configured to fill the curing chamber with heavy gas; and
a removable light source, attached to the housing and directed toward the curing chamber.

43. The apparatus of claim 42, wherein the curing chamber is below the level of the entrance portal and the exit portal.

44. The apparatus of claim 42 wherein the conveyor track is continuous.

45. The apparatus of claim 44 wherein the conveyor track has an upper level for loading the article, a lower level for moving the article through the curing chamber and a middle level for unloading the article.

46. The apparatus of claim 42 wherein the driver motor is variable speed.

47. The apparatus of claim 46 wherein the driver motor is a single phase A/C motor.

48. The apparatus of claim 42 wherein the heavy gas is CO₂.

49. The apparatus of claim 42 wherein the heavy gas is noble gas.

50. The apparatus of claim 42 wherein the removable light source is supported by a slidable frame within the curing chamber.

51. The apparatus of claim 42 wherein the removable light source includes an internally facing reflector.

52. The apparatus of claim 42 wherein the removable light source includes a plurality of removable light sources, each supported by a slidable frame.

53. The apparatus of claim 42 wherein the removable light source includes an ultraviolet lamp tube.

54. The apparatus of claim 42 wherein the removable light source includes an ultraviolet arc lamp.

55. The apparatus of claim 42 wherein the heavy gas supply includes a gas level sensor configured to report a signal when the heavy gas fills the curing chamber.

56. The apparatus of claim 55 wherein the signal represents an O₂ concentration of less than 5% by volume.

57. A controller for coordinating steps for curing products in a heavy gas comprising:
a microcontroller;
a memory connected to the microcontroller;
a display connected to the microcontroller;
an analog to digital connector connected to the microcontroller, having outputs to drive a gas control solenoid, a driver motor and an ultraviolet light source;
the microcontroller programmed to carry out the following steps:
activate heavy gas flow to a curing chamber;
activate the ultraviolet light source; and,
activate the driver motor.

58. The controller of claim 57 wherein the microcontroller is programmed to carry out the additional stops of:
reading the gas level from the gas level sensor;
if the gas level is below a predetermined level, sending an alarm to the display;
reading the door sensor;
if the door sensor reports an open door, then sending an alarm to the display.

59. The controller of claim 57 wherein the microcontroller is programmed to carry out the additional steps of:
closing the gas control solenoid;
deactivating the driver motor; and
deactivating the ultraviolet lamp.

60. The controller of claim 59 programmed to deactivate the driver motor by a controlled slowing.

61. The controller of claim 59 wherein the step of deactivating the ultraviolet lamp comprises the step of:
maintaining current to a cooling fan for a predetermined time; and
deactivating current to the cooling fan.

62. The controller of claim 57, further programmed to
enter a program mode;
accept input from a digital keypad comprising a speed for the driver motor, a cool-down time for the ultraviolet lamp and a gas rate for the gas solenoid; and
storing the input in the memory.

63. The controller of claim 62 further programmed to retrieve the input.

64. The controller of claim 57 wherein the microcontroller is a programmable logic device.

65. The controller of claim 57 wherein the microcontroller is a personal computer.

66. A chamber for irradiating a product coated with a light curable composition comprising:
a sealed chamber with an open top and a first side access panel;
a slidable light carriage within the sealed chamber and removable through the side access panel;
a first ultraviolet lamp module mounted on the light carriage and directed within the chamber; and
a first reflector attached to the carriage and positioned to reflect light from the ultraviolet lamp module.

67. The chamber of claim 66 wherein the light curable composition is laromer™ lr 8987, urethane acrylate hexandioldiacrylate, laromer™ lr 8863, polyetheracrylate iragucure™ 184, photoinitiator lucirin™ tpo, tinuvin™ 400 or UV absorber tinuvin™ 292.

68. The chamber of claim 66 wherein the light curable composition is 35 weight % laromer™ lr 8987, 20 weight % urethane acrylate hexandioldiacrylate, 38.5 weight % laromer™ lr 8863, 3.5 weight % polyetheracrylate iragucure™ 184, 0.5 weight % of a photoinitiator lucirin™ tpo, 2 weight % tinuvin™ 400 or 1.5 weight % UV absorber tinuvin™ 292.

69. The chamber of claim 66 further comprising:
a second side access panel;
a second light carriage within the sealed chamber and removable through the second side access panel;
a second ultraviolet lamp module mounted on the light carriage and directed within the chamber; and
a second reflector attached to the carriage and positioned to reflect light from the second ultraviolet lamp module.

70. The chamber of claim 66 wherein the first and second reflectors are positioned to reflect light from the first and second ultraviolet lamps.
